(19) United States
(12) Patent Application Publication
(10) Pub. No.: US 2008/0184678 A1
(43) Pub. Date: Aug. 7, 2008

(54) Horse protection equipment ventilation structure

(76) Inventor: Ju-Sung Chang, Nantou (TW)

Correspondence Address: BACON & THOMAS, PLLC, 625 SLATERS LANE, FOURTH FLOOR, ALEXANDRIA, VA, 22314, US

(21) Appl. No.: 11/702,533

(22) Filed: Feb. 6, 2007

(51) Int. Cl. B68B 7/00

(52) U.S. Cl. 54/65; 54/66

(57) ABSTRACT

A horse protection equipment ventilation structure, the design of which specifically provides for aeration and ventilation at the horse-equipment contact area during the usage of saddles, heel protectors (boots), headgear, and other horse protection applications to eliminate perspiratory suppression and discomfort problems due to over tightening. The structural design features a ventilation pad that is assembled to a predetermined position on the interior surface of various horse protection equipment of assorted shape. The ventilation pad is fabricated of a tactile-feel, exceptional quality resilient material, which in addition to a plurality of arrayed vent holes, has various protruding patterns of predetermined shape formed on its interior surface. Furthermore, assorted reticulations and indentations are disposed on the protruding patterns. When protection equipment integrating the invention herein is fastened onto the body of a horse, the material characteristics of the ventilation pad enable the movement of the horse to generate opening, closure, contact, and separation that increases airflow which optimizes ventilation. As such, the present invention improves the prior art shortcomings of perspiratory suppression and discomfort problems resulting from the over tightening of horse protection equipment onto horses.

### BACKGROUND OF THE INVENTION

1) Field of the Invention

The invention herein relates to a horse protection equipment ventilation structure, the structural design of which utilizes reticulations and indentations on protruding patterns of a ventilation pad that is assembled to the interior surface of horse protection equipment, thereby keeping the protection equipment from becoming totally flush against the body of the horse as well as enabling opening, closure, contact, and separation accompanying the movement of the horse to increase aeration and ventilation for greater horse comfort.

2) Description of the Related Art

In conventional horseback riding applications, to obtain rider and horse comfort and safety, a saddle, girth, boots, headgear, and other protection equipment are typically utilized, said protection equipment effectively preventing excessive friction between the rider and the body of the horse that results in mutual discomfort to both of them and, furthermore, safely protects the horse from injury at its most vulnerable places to thereby achieve the practical values of both comfort and protection.

Such horse protection equipment is typically constructed of leather or rubber (plastic) sheeting and other similar elastic materials to provide for comfortable contact when covering the horse by preventing excessive friction to the body of the horse that leads to discomfort. However, when such protection equipment covers the body of the horse, the interior surface is entirely flush against the body of the horse and, under these conditions, ventilation is obviously less than optimal at the area of flush contact by said protection equipment. Furthermore, sweat secreted as the horse gallops and moves very easily gives rise to stifled bodily heat and dampness attributable to perspiratory obstruction at the site of said area that not only results in horse discomfort, but also possible pathological skin conditions that affect its overall health. As such, a means must be found to effect solution and improvement.

To solve these problems, although vent holes have been additionally disposed at the appropriate locations in some horse protection equipment to exhaust heat and moisture through the vent holes in an effort to improve the stifled bodily heat and dampness problem, the vent holes are merely of a simple through-flow design and the interior aspect of such horse protection equipment remains largely planar and, as a result, when such protection equipment is covered onto the body of the horse, much of its interior aspect is still flush against the horse and, furthermore, since the heat-moisture dissipation efficiency of the vent holes is less than ideal, excessive stifling of bodily heat and dampness due to perspiratory suppression occurs nonetheless to the extent that it is difficult to concur that such designs are without flaw.

### SUMMARY OF THE INVENTION

In view of the existent problems and shortcomings of the prior art horse protection equipment, the inventor of the invention herein conducted research to improve them based on experience and technical skills gained through many years of professional experience in the relevant industrial fields, which culminated in the development of the horse protection equipment structure of the invention herein, of which the primary objective is to provide a structural design arrangement, wherein when the horse protection equipment covers the body of the horse, the interior surface thereof is not completely flush against the horse, thereby increasing airflow to effectively promote heat and moisture dissipation.

Another objective of the invention herein is to provide a structural design arrangement, wherein said protection equipment is capable of opening, closure, contact, and separation actions that accompanies movements by the body of the horse to thereby significantly raise airflow and heat dissipation efficiency, ensuring that the contact area does not inhibit perspiratory processes such that in addition to attaining safe and protective performance, said protection equipment also provides for the comfort of the horse.

To achieve said objectives, the structural design arrangement of the invention herein utilizes along the interior surface of the horse protection equipment a ventilation pad, the structural design of which consists of protruding patterns, reticulations, and indentations, such that it cannot become completely flush against the body of the horse and, furthermore, is capable of repeated opening, closure, contact, and separation which accompanies the movement of the horse, thereby increasing air flow and ventilation to enhance the comfort of the horse.

To further explain the structural arrangement, technological means, and capabilities of the present invention, the brief description of the drawings below accompanies the detailed description of the preferred embodiments.

### BRIEF DESCRIPTION OF THE DRAWINGS

FIG. 1 is an isometric drawing of the most preferred embodiment of the structure of invention herein.

FIG. 2 is a cross-sectional drawing relating to the structure of the most preferred embodiment of the invention herein.

FIG. 3 is a cross-sectional drawing relating to the structural movement of the most preferred embodiment of the invention herein.

FIG. 4 is an orthographic drawing of another most preferred embodiment of the invention herein.

FIG. 5 is an orthographic drawing of another most preferred embodiment of the invention herein.

FIG. 6 is an orthographic drawing of another most preferred embodiment of the invention herein.

FIG. 7 is an orthographic drawing of another most preferred embodiment of the invention herein.

### DETAILED DESCRIPTION OF THE PREFERRED EMBODIMENTS

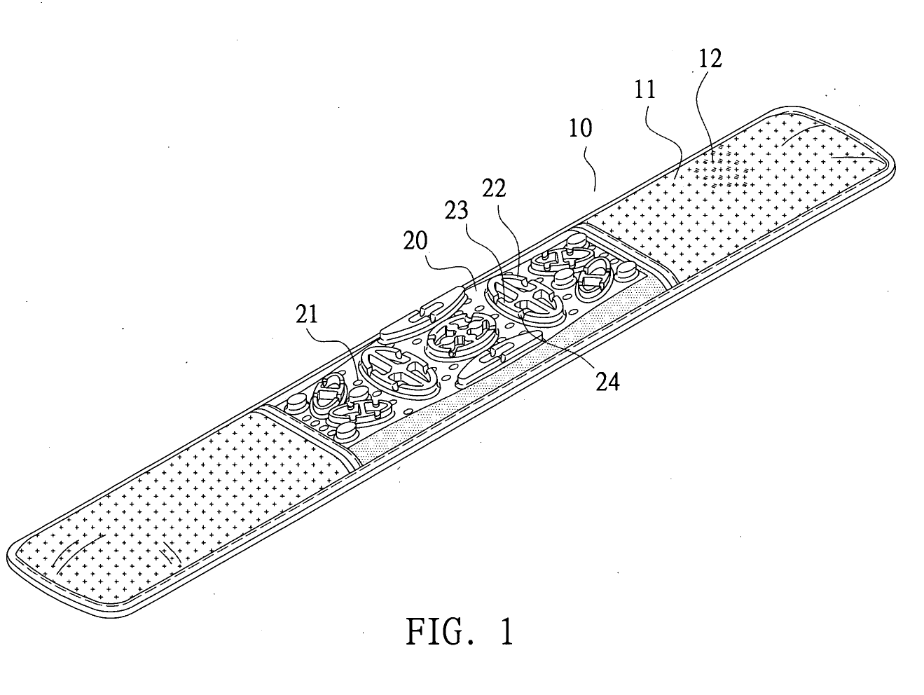

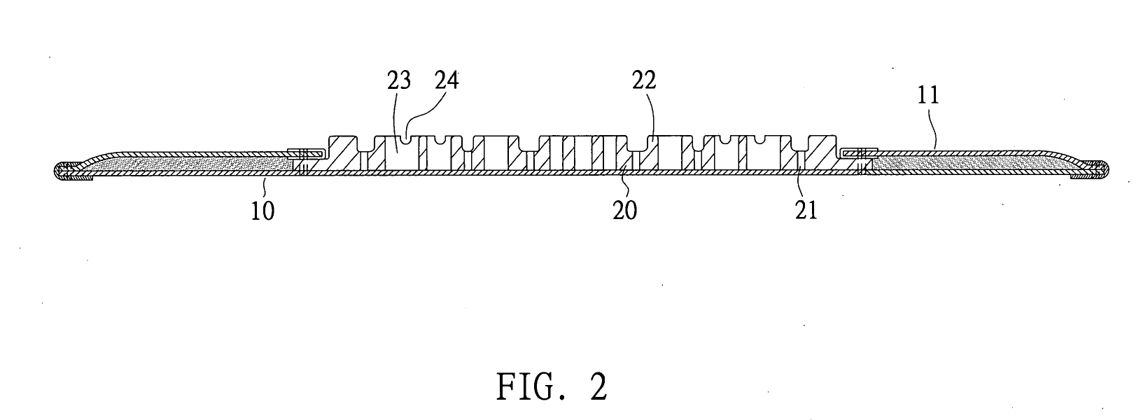

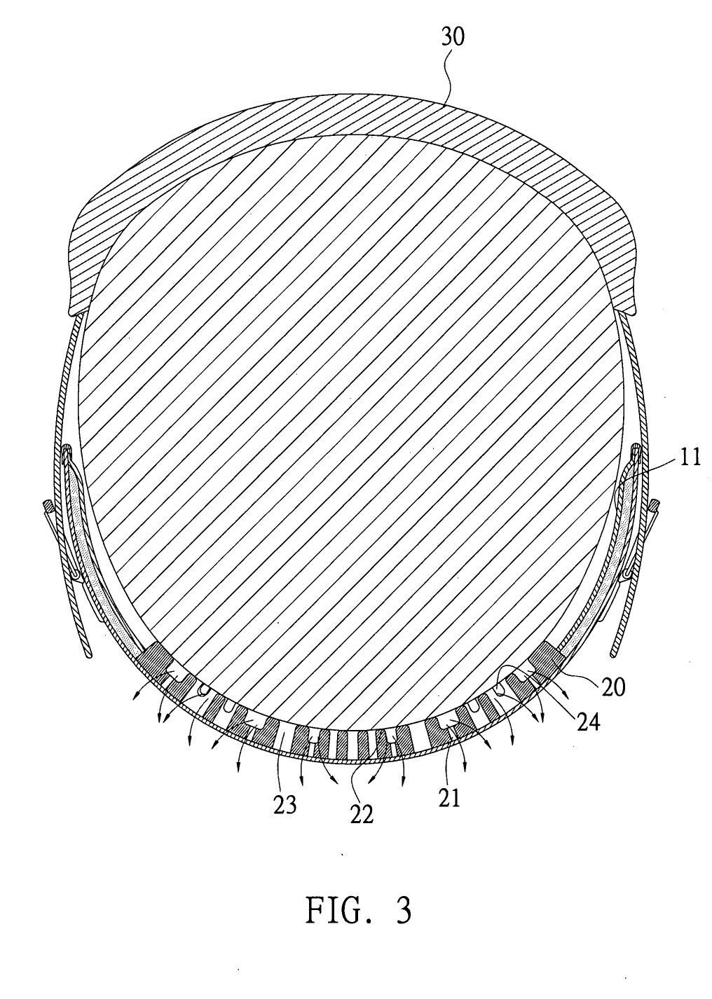

Referring to FIG. 1, FIG. 2, and FIG. 3, the drawings of one most preferred embodiment of the invention herein in the form of a horse girth for explanatory purposes, the structural design of which consists of a long-shape belt 10; an inner layer of soft pad 11 fabricated of a pliable, tactile-impressive elastic material; a concave-convex pattern 12 suitably arrayed on the soft pad 11 for non-planar contact between the soft pad 11 and body of the horse; a ventilation pad 20 additionally disposed at a designated area along the interior surface of the belt 10, said ventilation pad 20 fabricated of a tactile-feel resilient material (such as TPE Gel and Eureka TPE, etc.) that is sewn onto the belt 10 to form a single structural entity; a plurality of vent holes 21 arrayed on said ventilation pad 20; various protruding patterns 22 of a circular, ovular, columnar, or other predetermined shape formed on the interior surface of the ventilation pad 20 and, furthermore, assorted reticulations 23 and indentations 24 of predetermined contour disposed on said protruding patterns 22, such that when a saddle 30 so equipped is fastened over the back of horse by means of the belt 10, said ventilation pad 20 is not totally flush against the body of the horse, which comprises the ventilation structure of the belt 10.

In the preceding disclosure of said belt 10, due to the construction of the ventilation pad 20 disposed along its interior surface that integrates by design the protruding patterns 22 and the indentations 24, the ventilation pad 20 does not become completely affixed flush to the abdomen of the horse and, furthermore, the material properties of the ventilation pad 20 enable repeated opening, closure, contact, and separation accompanying the movement of the horse, thereby increasing airflow and ventilation, while also efficiently augmenting heat dissipation, ensuring that the wearing of the belt 10 does not overly inhibit perspiratory processes to thereby enhance the physical comfort of the horse, which thoroughly solves the problem of conventional horse girth over tightening that leads to obstructed perspiration.

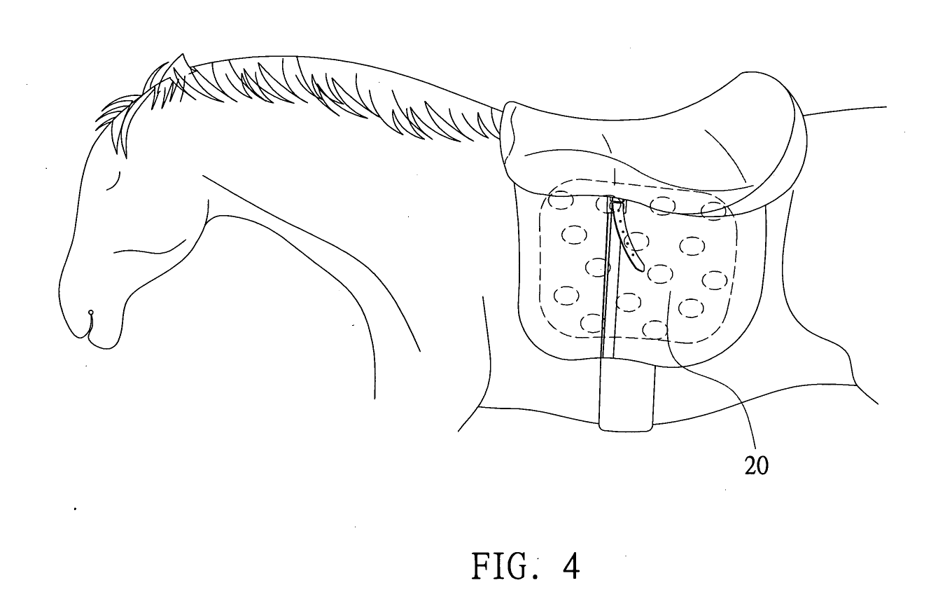

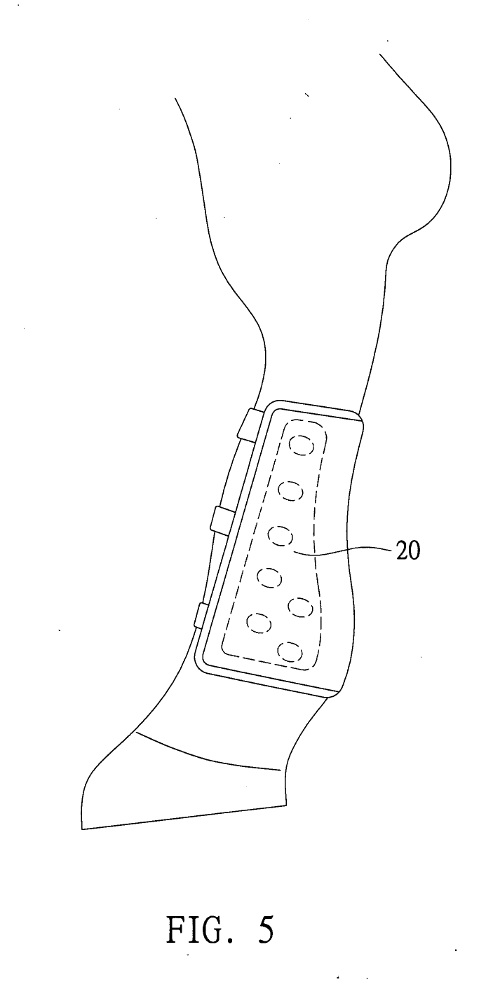

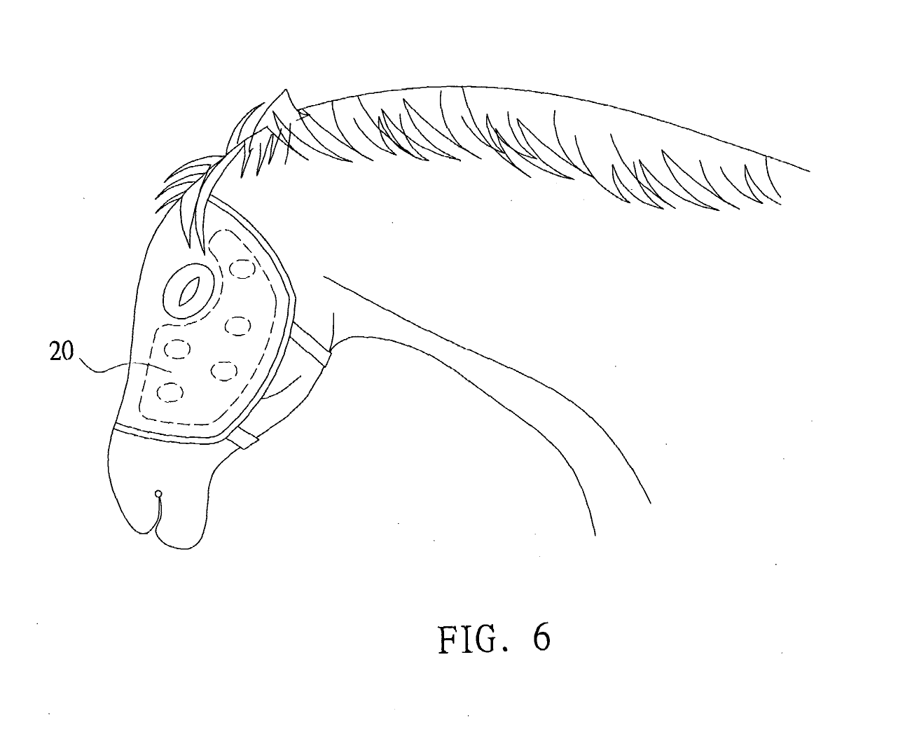

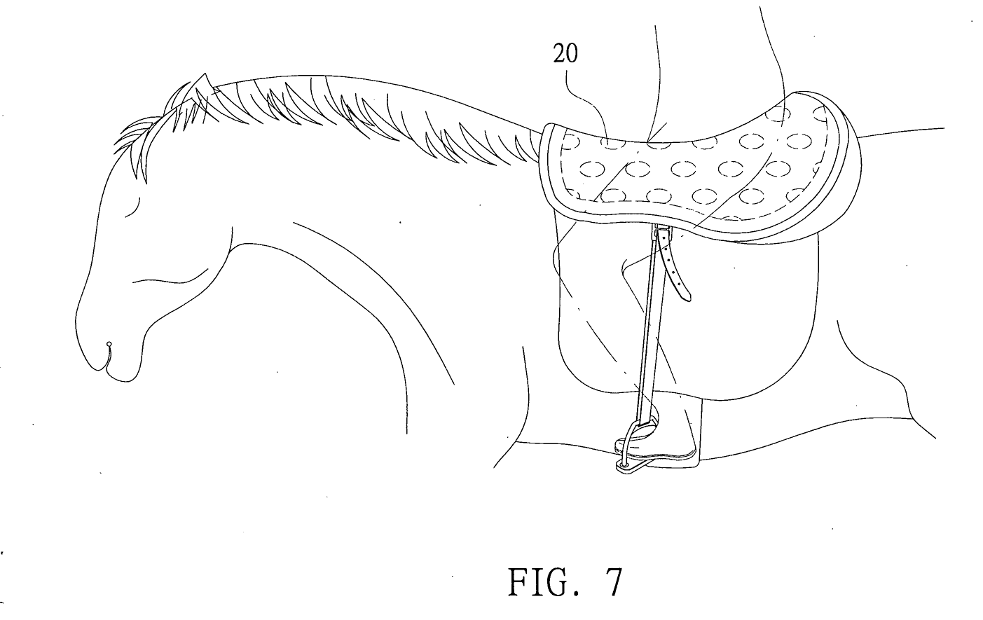

Referring to FIG. 4, FIG. 5, FIG. 6, and FIG. 7, as depicted in the drawings, in addition to utilization in the horse girth disclosed above, the horse protection equipment ventilation structure of the invention herein can be utilized in saddles, heel protectors (boots), headgear, and other horse protection applications (as shown in FIG. 4, FIG. 5, and FIG. 6, respectively), and in implementation the configuration and placement of the ventilation pad 20 is not limited to that of the present arrangement, but to accommodate protection equipment shape dissimilarities and utilization position differences, the ventilation pad 20 can be disposed at predetermined positions on the interior surface of various horse protection equipment, wherein the protruding patterns 22, indentations 24, and arrayed vent holes 21 of the ventilation pad 20 maintain a suitable intervallic spacing between the protective equipment and the body of the horse, which produces an appropriate opening, closure, contact, and separation that occurs as the horse moves to promote airflow and heat dissipation which effectively prevents preparatory irregularities between the protective equipment and the contact area on the body of the horse as well as averts the associated dermatological pathologies, thereby enhancing horse comfort and health and, moreover, effectively solving the numerous problems and drawbacks existing in the conventional structure and, furthermore, said ventilation pad 20 structure can also be utilized at the rider contact surface on the back of a saddle to similarly provide for ventilation between the rider and the saddle, thereby preventing rider discomfort due to aeration blockage (see FIG. 7).

Based on the foregoing description, the invention herein provides for a ventilation structure disposed at the area of physical contact between horse protection equipment and the body of a horse, which in addition to conventional vent hole design, also includes a structure of protruding patterns 22 and indentations 24 formed on the interior surface of the ventilation pad 20 that keeps the protection equipment from becoming totally flush against the body of the horse and, furthermore, effectively provides for opening, closure, contact, and separation as the horse moves to promote airflow and heat dissipation, such that in comparison with the stifled breathability and discomfort problems produced by prior art horse protection equipment, the invention herein not only enables such equipment to safely protect horses, but to also maintain comfort during usage; as such, the present invention possesses exceptional manufacturing utility value.

In summation of the foregoing section, since the horse protection equipment ventilation structure of the invention herein, the structure of which is of improved design, ensures the effective aeration and ventilation between horse protection equipment and the body of the horse to thoroughly solve the stifled breathability and discomfort problems existing in conventional horse protection equipment, while also affording safe protection as well as maintained comfort during usage, therefore, the present invention possesses exceptional manufacturing utility value and features a unique as well as advanced innovative design and, as such, is lawfully submitted in application for the commensurate patent rights.

What is claimed is:

1. A horse protection equipment ventilation structure that effectively provides for aeration and ventilation between horse protection equipment and the body of the horse in a design that prevents perspiratory suppression and discomfort problems produced at the contact area between the protection equipment and the body of the horse, the unique features of which include:
said horse protection equipment has a ventilation pad assembled to predetermined positions on its interior surface, said ventilation pad fabricated of a tactile-feel, exceptional quality resilient material; various protruding patterns of predetermined shape are formed on the interior surface of said ventilation pad and, furthermore, assorted reticulations and indentations are disposed on said protruding patterns, such that said protection equipment is not totally flush against the body of the horse when securely fastened, enabling repeated opening, closure, contact, and separation accompanying the movement of the horse that promotes air flow and heat dissipation to prevent perspiratory suppression and discomfort problems.

2. A horse protection equipment ventilation structure as claimed in claim 1 in which said ventilation pad can be utilized in saddles, heel protectors (boots), headgear, and other horse protection applications.

3. A horse protection equipment ventilation structure as claimed in claim 1 in which said ventilation pad is fabricated of TPE Gel.

4. A horse protection equipment ventilation structure as claimed in claim 1 in which said protruding patterns of said ventilation pad are of a circular, ovular, columnar, or other predetermined shape.

5. A horse protection equipment ventilation structure as claimed in claim 1 in which said ventilation pad is assembled to the interior surface of protection equipment by means of sewing.

6. A horse protection equipment ventilation structure as claimed in claim 1 in which said ventilation pad is arrayed with a plurality of vent holes.

7. A horse protection equipment ventilation structure as claimed in claim 1 in which said ventilation pad can be implemented on the back of a saddle to provide for ventilation between a rider and the saddle.
